(19) United States
(12) Patent Application Publication
(10) Pub. No.: US 2010/0072923 A1
(43) Pub. Date: Mar. 25, 2010

(54) ELECTRICAL CONNECTION BETWEEN AT LEAST TWO PARTS AND ELECTRICAL DEVICE WITH SUCH A CONNECTION

(76) Inventors: Jonann Holland, Schernfeld (DE); Andreas Nittke, Pietenfeld (DE)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/451,616

(22) PCT Filed: Jun. 9, 2008
(86) PCT No.: PCT/EP2008/057175

§ 371 Date: Nov. 20, 2009

(30) Foreign Application Priority Data
Jun. 28, 2007 (DE) 202007009060.9

(51) Int. Cl. H01J 5/50; H01R 4/28

(52) U.S. Cl. 315/363; 439/775; 313/318.12

(57) ABSTRACT

The invention relates to an electrical connection between two parts, one of which is a wire and the second is a sleeve, wherein the wire has a diameter DR, and wherein the sleeve has, at least sectionally, an inner diameter ID, and wherein DR is smaller than ID. The end of the wire leads into the hollow body, wherein the end of the wire has a means for securing a connection to the hollow body.

### TECHNICAL FIELD

The invention relates to an electrical connection in accordance with the preamble of claim 1. Said connection is an electrical connection between two parts, usually a wire and a hollow body. The connection can also include a plurality of parts, for example two wires and a hollow body. Furthermore, the invention relates to an electrical device which contains at least one electrical connection of this type. Said electrical device is in particular an electric lamp of any type, or else a starter for lamps, for example. The application of the connection is not restricted thereto, however.

### PRIOR ART

A connection between a wire and a hollow body, in particular a sleeve, has until now been produced, for example, by a screw being provided on the sleeve, which screw is used to clamp the wire between the sleeve wall and the screw. Another previously known technology of a connection consists in soldering or welding both parts to one another. It is likewise known to deform the sleeve, in particular to crimp it, with the wire being pinched in between the wall of the sleeve. However, all of these solutions have the disadvantage that a working step such as screwing, soldering, welding or deformation is required in order to produce the connection. It is furthermore known to produce a connection by means of clamping, in the case of which the wire is held by a latching apparatus, and this clamping connection can be released again, if appropriate.

### DESCRIPTION OF THE INVENTION

The object of the invention is to provide an electrical connection between two parts in accordance with the preamble of claim 1 which requires as few working steps as possible. A further object is to provide a connection which can be produced in a simple and inexpensive manner.

The object of the invention is achieved in the case of a connection in accordance with the preamble of the first claim by virtue of the fact that the connection is designed to be self-inhibiting, namely in such a way that the wire is anchored in the hollow body, in particular in a sleeve.

Anchoring a wire in a hollow body can in principle be produced in a wide variety of ways. According to the invention, means which have a self-inhibiting effect in the hollow body are provided at least on the wire. In particular, a means which supports the connection can also be formed on the hollow body. The wire can be plugged into the hollow body and then latched therein, with the result that it can no longer be withdrawn without an excessively high amount of force being exerted or without the use of mechanical forces. This makes rapid fitting of the connection possible.

Preferably, the hollow body is a sleeve or a peg with a blind hole. By way of example, a sleeve is used below.

It has proven to be particularly advantageous to provide a connection between the wire and a sleeve which manages without any additional means. In particular, such a connection is achieved by virtue of the fact that the self-inhibiting effect can be brought about by a measure on the wire on its own or in conjunction with a means on the sleeve. For example, the wire can be designed to be corrugated in the region with which it protrudes into the sleeve. The amplitude of the corrugations is selected to be so great that the wire bears in frictionally engaged fashion against the wall of the sleeve. Then, the wire can now only be withdrawn from the sleeve with a large amount of force being exerted. In most cases, such a force-fitting connection is sufficient for providing sufficient connection between the wire and the sleeve.

In accordance with a further embodiment, the inner side of the sleeve, as the supporting means, is roughened or has projections in order to increase the frictional force.

In accordance with a particularly advantageous embodiment of the invention, the wire is provided with an end which is bent back in the form of a hook as the means. With this barb, the wire can hook in the sleeve. When the wire is drawn counter to the plug-in direction, the wire end is braced against the inner side of the sleeve and the force required to withdraw the wire from the sleeve is increased.

It has proven to be particularly favorable if the bent-back wire end is designed to be resilient. When the wire is plugged in, the elastic hook slides easily along the wall of the sleeve. When the wire is withdrawn, however, said hook is braced in such a way that it can no longer be easily withdrawn. The force with which the wire end is pressed against the inner side of the sleeve is yet further increased in comparison with the previously described solution. An even greater force is required to withdraw the wire from the sleeve.

In accordance with a very particular embodiment of the invention, latching means which interact with the bent-back wire end are additionally provided on the inner side of the sleeve. In this case, the latching means can comprise one or more projections or depressions, which are either integrally formed or applied on the sleeve. In particular, said latching means is at least one peripheral channel, with the result that the orientation of the wire or the end thereof is no longer relevant. Advantageously, a plurality of channels can be arranged one behind the other.

In accordance with an advantageous exemplary embodiment, the latching means comprise lugs, which are integrally formed on the inner side of the sleeve. These lugs can be formed by tabs being punched, which tabs are bent inwards into the sleeve. In accordance with a further exemplary embodiment, the lug can also be produced by upsetting the sleeve in its longitudinal direction. The material of the sleeve is compressed in the upsetting region, with the result that the wall of the sleeve is thicker in this region and therefore protrudes inwards or outwards or inwards and outwards beyond the remaining wall. In this way, an annular bead is formed at least on the inner side of the sleeve, which bead is provided as an abutment for the bent-back wire end. A peripheral bead has the advantage that the point at which the wire bears against the wall and the manner in which said wire is inserted into the sleeve are not important. Said wire will always find an abutment.

A further possibility of producing a projection consists in providing the sleeve with a collar at one end or else at both of its ends. The collar can already be integrally formed, for example during the production of the sleeve in the deep-drawing process. In this case, the collar is angled inwards and thus forms the abutment for the bent-back wire end.

In accordance with another exemplary embodiment, the latching means comprises a depression or dent, which is introduced into the sleeve wall. The depression can be produced by means of embossing, and the aperture can be produced by means of punching, for example.

It has proven to be advantageous to design the depression in the form of a peripheral groove. In this case, the wire end latches into the groove and thus unintentional withdrawal of the wire is prevented. Such a groove is likewise produced, for example, by means of upsetting the sleeve in the longitudinal direction thereof. In accordance with this specific method, an annular bead is produced on the outer side of the sleeve and the desired annular groove is produced on the inner side.

By virtue of a movement in the plug-in direction, the wire or the wire end is inserted into the sleeve and when drawn counter to the plug-in direction, the wire becomes hooked on the sleeve wall or on the latching means and can only be withdrawn with a large amount of force being exerted or can no longer be withdrawn from the sleeve at all.

It has proven to be favorable to produce the sleeve without cutting. Said sleeve advantageously comprises a deep-drawn part. However, it can also be formed by extrusion, rotary kneading or another manufacturing process which does not involve cutting. An additional advantage of a production process which does not involve cutting in comparison with a form of manufacture which does involve cutting consists in the fact that a lead-free material can be used. The sleeve advantageously comprises lead-free brass. A material with an addition of approximately 2% lead can be used for manufacture which involves cutting. However, lead is an environmentally harmful material, for which reason it is advantageous not to use this material in the sleeves any more.

It is advantageous to use a sleeve with a wall thickness of at most 0.5 mm, preferably 0.2 to 0.35 mm, for the manufacture without cutting, in particular deep-drawing. This is favorable for the anchoring of the wire and saves a considerable amount of material for the production of the sleeve.

The invention makes it possible to use such a thin material for the sleeve. However, it is also possible to use turned parts, specifically as the sleeve or else as the peg with a blind hole. In this case, it is still possible to make a considerable saving on material in comparison with conventional thick-walled sleeves.

Only the connection technique with holding means on the wire provides the precondition for using thin-walled sleeves. In the case of said sleeves, there is insufficient material available for crimping. In this case, soldering would be too expensive and too involved. It is now possible to use sleeves which typically have an inner diameter ID of 0.5 to 2 mm, given a length L of the sleeve of several mm. Such a relationship ID:L of typically 1:4 to 1:10 cannot be produced using extrusion.

The wire and the sleeve are suitable for a large number of connections, with it also being possible for a plastic part provided with a hook to be provided instead of a wire, for example.

By way of a specific intended use, the connection according to the invention is used as an electrical connection. The sleeve and the wire are made from an electrically conductive material. In particular, brass is used for the sleeve and molybdenum or a molybdenum alloy is used for the wire. Further materials which can preferably be used are stainless steel or CPS (copper-plated steel).

In accordance with a preferred exemplary embodiment, the wire comprises a spring wire in order that the end which is bent back in the form of a hook bears in a resilient manner against the inner, side of the sleeve and is supported against the or the plurality of latching means.

Advantageously, it is provided that the connection is used in electrical devices, in particular in lamps such as halogen incandescent lamps or reflector high-pressure discharge lamps, or in starters for fluorescent lamps. Electric lamps and starters have a base, for example. The power supply wires passed out of the lamp vessel or the starter sleeve need to be connected to the electrical terminals of the base. Often, those ends of the power supply wires which protrude out of the lamp vessel or the starter sleeve are too short to be able to be connected to the contacts of the base.

It is necessary for these ends to be extended. These extensions have until now been provided by so-called wire attachments, for example (see DE-U 202006005158). Now, for example, the above-described sleeves are used as the extension couplings. Connecting wires provided with hook-shaped ends are inserted into these sleeves from both sides and then, if appropriate, interact additionally with the wall or the latching means.

In accordance with a further exemplary embodiment, the sleeve is provided as a contact pin, in particular as a contact pin for a base, such as a bayonet-type base. In this case, the sleeve is preferably a deep-drawn part, this deep-drawn part having sections with different diameters. Specifically for the bayonet-type base, the contact pin has a wider lower end which interacts in holding fashion with the narrower region of a keyhole-shaped cutout, for example a lampholder. The power supply wire is inserted into the sleeve from that side which is opposite the wider end of the sleeve.

The contact pin typically has a diameter of 2.5 to 3.5 mm, advantageously a diameter of approximately 3 mm, in the narrower region thereof. The diameter of the wider section is typically approximately 5 mm.

For optimum functioning of the connection, an interesting parameter is the ratio of the wire diameter DR to the inner diameter ID of the sleeve or the hollow body, which has an optimum value, for example, of DR:ID of 3.5 to 7, preferably 4 to 6. In the case of larger inner diameters relative to DR, the hook will be long and therefore unstable, and in the case of smaller inner diameters, the bending radius of the wire will be extremely small and the risk of wire breakage will increase, primarily when using the molybdenum which is preferred per se as the material.

In comparison thereto, the absolute dimensions of the sleeve play a subordinate role. In principle, it is also possible for a 1 cm thick structural steel to be fixed in a 5 to 10 cm thick sleeve in which case only the durability of the connection, and not the electrical contact, is important.

When using the sleeve in reflector lamps, the sleeve can also be used for fastening the lamp in the reflector shell. The reflector shell has in the vertex region thereof, namely the reflector bottom, openings into which the sleeves can be inserted. The sleeve is provided on its outer side with projections or a peripheral annular bead, which bears against the outer side of the reflector shell. The sleeve protrudes through the opening. When the sleeve has been plugged through the opening, the end protruding into the interior of the reflector is flanged. The reflector shell or the reflector bottom is then clamped in between the projections or the annular bead and the flange and thereby fixed. Now, the lamp can be plugged into the sleeves with its power supply wires. The bent-back ends of the power supply wires hook behind the latching means and the lamp can no longer be withdrawn. With this type of fastening of the lamp in the reflector, it is possible to subsequently adjust the lamp in relation to the reflector.

In a further exemplary embodiment, the position of the lamp is fixed with respect to the reflector shell by an additional plate-shaped holder. This holder rests on a peripheral shoulder on the inner side of the reflector shell. This holder is advantageously designed to be resilient. When the lamp is inserted into the sleeves, the lamp is pressed against the holder and bends the holder slightly. The position of the latching means in the sleeve is arranged such that the bent-back ends of the power supply wires then latch behind the latching means. If the lamp is released again, the holder springs back into its initial position. The lamp is now arranged in the desired position with respect to the reflector.

The tension force of the holder is, for example, 0.1 to 1 or else several N (Newton). It is preferably below a tension force of typically 0.3 N. A structural unit designed in this way simplifies the adjustment of the lamp and avoids maladjustment. The lamp is fixed by this type of fastening also in terms of its position and therefore cannot rock. Rattling noises are likewise avoided. It is likewise possible to dispense with additional holding means, such as adhesive or cement, since the holder is pressed against the shoulder by the tension force.

The tension force can also be absorbed by the resilient, bent-back ends of the power supply wires. The holder fixing the lamp can therefore also be formed from a non-resilient part. It is likewise possible for the lamp to bear against a holder which is integrally formed on the reflector shell, for example a step.

### BRIEF DESCRIPTION OF THE DRAWINGS

The invention will be explained in more detail below with reference to a plurality of exemplary embodiments. In the figures:

FIG. 1 shows a section through a reflector lamp with a bayonet-type base;

FIG. 2 shows an enlarged illustration of the detail of the reflector lamp shown in FIG. 1 in the region of the connection;

FIGS. 3-8 show a further embodiment of the sleeve;

FIG. 9 shows an embodiment of a starter.

### PREFERRED EMBODIMENT OF THE INVENTION

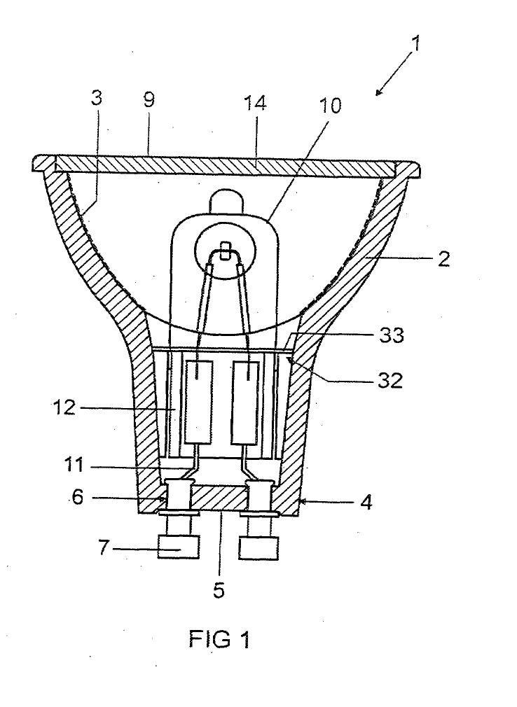

FIG. 1 illustrates a reflector lamp in section. The reflector lamp is denoted by 1. The reflector lamp 1 comprises a reflector shell 2, which is provided on its inner side with a reflective coating 3. A base 4 is integrally formed on the reflector shell 2 at the lower end. In accordance with this exemplary embodiment, the base body 4 is made from the same material as the reflector shell 2 itself and is an integral part of the reflector shell 2. Often, it is also a separate part. In the vertex region of the reflector shell 2 or at the lower end of the base 4, namely at the reflector bottom 5, two openings 6 are provided. In each case one contact pin 7 is inserted into these openings 6. An inner bulb 10 with a halogen-containing fill sits in the reflector shell 2. Power supply lines 11 are passed out of the pinch seal 12 of the inner bulb and held in contact pins 7, which in principle represent sleeves.

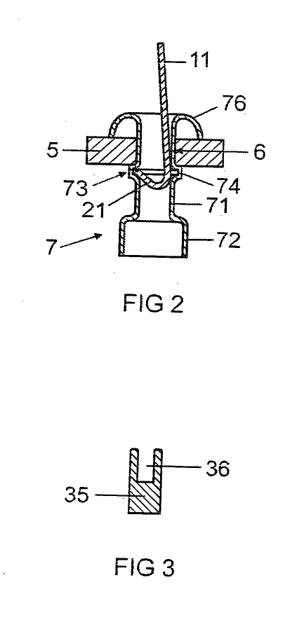

The contact pin 7 is illustrated in more detail in FIG. 2. It comprises a sleeve. The sleeve is produced as a deep-drawn part. It substantially comprises two sections 71, 72, which have different inner diameters. With the thinner section 71, the sleeve is partially plugged through the opening 6. The wider section 72 forms that part of the contact pin 7 which interacts in connecting fashion with the keyhole-shaped receptacle of a lampholder (not illustrated), as is known per se.

The contact pin 7 is upset at the point 73 in its thinner section 71. The upsetting produces an annular bead 74 on the outer side of the sleeve. A peripheral annular groove 75 is produced on the inner side of the sleeve. These features of the sleeve are illustrated in enlarged form in FIG. 2. Identical parts in FIG. 1 and FIG. 2 have been provided with the same reference symbols.

The annular bead 74 acts as a stop for the sleeve in the opening 6. The sleeve is plugged into the opening 6 as far as the stop and protrudes out of the reflector bottom 5 and into the reflector shell on the other side. Then, that end of the contact pin 7 which protrudes into the interior of the reflector shell is flanged on the reflector bottom 5. The reflector shell 2 or the reflector bottom 5 is now clamped in between the annular bead 74 and the flange 76.

Now, the inner bulb 10 of the lamp is inserted into the reflector shell 2 from the reflector opening 9. Those ends 21 of the power supply wires 11 which protrude out of the lamp vessel 10 are bent back in the form of hooks. The wire 11 is made from a resilient, electrically conductive material. The ends 21 of the power supply wires 11 are inserted into the sleeve, or in this case into the contact pins 7, as far as behind the annular groove 75. When the lamp is drawn back, the hook-shaped end 21 of the power supply wire 11 latches into the annular groove 75. The power supply wire 11 can now only be removed from the contact pin 7 again with a high level of force being exerted.

The reflector shell 2 has a step 32 on its inner side 3 in the transition region to the base 4. A plate-shaped holder 33, which is provided with a receptacle for receiving the bulb 10, rests against this step 12. This holder 33 determines the position of the lamp with respect to the reflector or the reflector shell 2.

The plate-shaped holder 33 is designed to be resilient. When the bulb 10 is inserted into the reflector shell 2, said bulb is pressed against the holder 33, with the result that said holder yields slightly. The lamp 8 is pressed against the holder 33 until the hook-shaped ends 21 of the power supply wires 11 latch into the annular groove 75. Then, the bulb 10 can be released. The holder 33 springs back with the bulb 10 into the position which is intended for the optimum light distribution of the reflector lamp 1. As a result of the tension force of the holder 33 in one direction and the tension force of the hook-shaped ends 21 of the power supply lines 11 in the opposite direction, the bulb 10 is clamped in, with the result that its position is fixed.

In order to fasten the bulb 10 in the reflector shell 2, the tension force which is brought about by the ends 21 of the power supply wires 11 is sufficient for fixing the lamp in its position. A less expensive material can thus be selected for the holder 33.

In this exemplary embodiment, the reflector opening 9 is closed by a covering disk 14; see FIG. 1.

FIG. 3 shows, as the hollow body, a peg 35 with a blind hole 36.

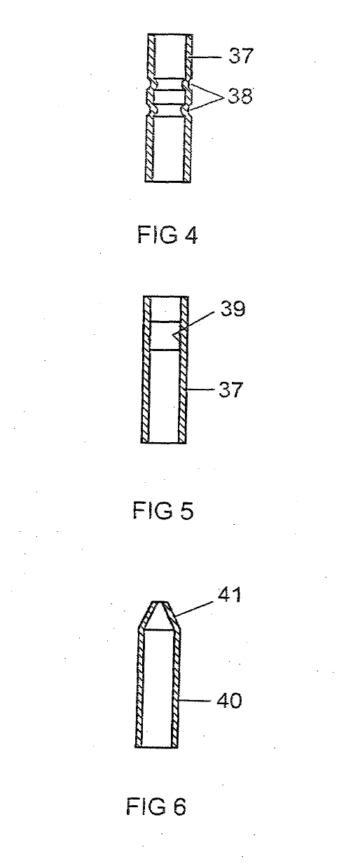

FIG. 4 shows, as the hollow body, a sleeve, 37 with two peripheral channels 38.

FIG. 5 shows, as the hollow body, a sleeve 37 with an inner roughened portion 39.

FIG. 6 shows, as the hollow body, a socket with a cylindrical main part 40 and a conical end 41.

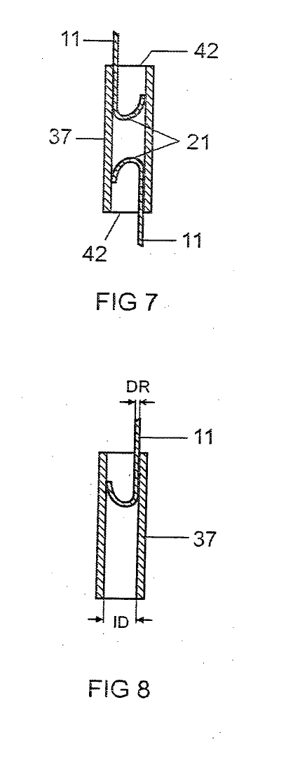

FIG. 7 shows a sleeve 37, which is used as an extension coupling, by a wire 11 with a bent-back end 21 being inserted at both ends 42.

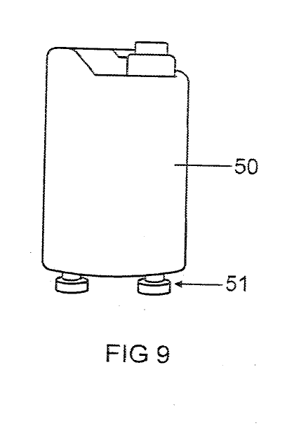

FIG. 8 shows a sleeve 37 with the given inner diameter ID and a wire 11 with the given diameter DR.

FIG. 9 shows a starter 50 with a base 51. Contact is made as illustrated by way of example in FIG. 2.

In principle it is even possible to use this type of connection for nonconductive parts as well. In this case, the wire is preferably a clad wire made from metal coated with plastic. The hollow body is a plastic part or a metal part coated with plastic.

In principle, another functionally identical shape of the end of the wire can also be used instead of a hook, for example a loop such as in the case of the covering cap of a spring holder which has first of all been bent back towards the wire and only then protrudes towards the inner wall of the sleeve.

1. An electrical connection between at least two parts, a first part being a wire with a diameter DR and a second part being a hollow body with an opening, at least sections of which have an inner diameter ID, characterized in that DR is smaller than ID, and in that the end of the wire is introduced into the hollow body, the end of the wire having a means which ensures a connection to the hollow body.

2. The connection as claimed in claim 1, characterized in that the connection is designed to be self-inhibiting in such a way that the wire is anchored in the hollow body.

3. The connection as claimed in claim 1, characterized in that the wire has a bent-back end as the means.

4. The connection as claimed in claim 3, characterized in that the end is bent back in the form of a hook.

5. The connection as claimed in claim 1, characterized in that, in addition, the hollow body has a supporting means.

6. The connection as claimed in claim 5, characterized in that the supporting means is a notch or a bulge in the hollow body.

7. The connection as claimed in claim 1, characterized in that the hollow body is a sleeve.

8. The connection as claimed in claim 1, characterized in that the wire end is supported against the inner wall of the sleeve.

9. The connection as claimed in claim 1, characterized in that the bent-back wire end is designed to be resilient.

10. The connection as claimed in claim 1, characterized in that the sleeve has at least one latching means on the inner side thereof.

11. The connection as claimed in claim 1, characterized in that the latching means comprises at least one projection provided on the inner side of the sleeve.

12. The connection as claimed in claim 1, characterized in that the projection is formed from one or more lugs or comprises a bead running around the inner side of the sleeve.

13. The connection as claimed in claim 1, characterized in that the projection comprises a collar protruding inwards at the opening of the sleeve.

14. The connection as claimed in claim 1, characterized in that the latching means comprises at least one depression provided on the inner side of the sleeve or an aperture.

15. The connection as claimed in claim 1, characterized in that the depression is in the form of a groove running around the inner side of the sleeve.

16. The connection as claimed in claim 1, characterized in that the annular bead is formed on the outer side of the sleeve and/or the groove is formed by upsetting the sleeve.

17. The connection as claimed in claim 1, characterized in that the wire end is inserted into the sleeve by virtue of a movement in the plug-in direction, and when the wire is drawn counter to the plug-in direction, the bent-back end of the wire hooks onto the wall of the sleeve and/or the latching means.

18. The connection as claimed in claim 1 characterized in that the wire and the sleeve are formed from an electrically conductive material.

19. The connection as claimed in claim 1, characterized in that the connection provides an electrically conductive connection.

20. The connection as claimed in claim 1, characterized by the use of the connection in electric lamps.

21. The connection as claimed in claim 1, characterized in that the electrical connection is provided between a power supply wire (11) and a contact pin (7).

22. The connection as claimed in claim 1, characterized in that a base (4) is provided and the contact pin (7) is part of the base (4).

23. An electric lamp, in particular an incandescent lamp, discharge lamp or a diode, comprising a hermetically sealed lamp vessel, at least one light-emitting element or electrodes, a power supply system, with which the light-emitting element or the electrodes are electrically conductively connected to a power source, the power supply system comprising at least power supply wires used to produce a connection between the parts of the lamp in the interior of the lamp vessel and the parts of the lamp outside the lamp vessel, and the lamp is connected to an electrical terminal, characterized by a connection as claimed in claim 1.

24. The electric lamp as claimed in claim 23, characterized in that a contact pin (7) is provided for the electrical terminal.

25. The electric lamp as claimed in claim 24, characterized in that the contact pin (7) is in the form of a sleeve.

26. The electric lamp as claimed in claim 23, characterized in that the wire of the connection is formed by the power supply wire (11) protruding out of the lamp vessel (10).

27. The electric lamp as claimed in claim 23, characterized in that the power supply wire (11) has a bent-back end (11/2) and the end (11/1) bears against the inner side of the contact pin (7).

28. The electric lamp as claimed in claim 23, characterized in that the inner side of the contact pin (7) is provided with latching elements.

29. The electric lamp as claimed in claim 23, characterized in that the latching element is formed by a peripheral groove (7/5) on the inner side of the contact pin (7).

30. The electric lamp as claimed in claim 23, characterized in that the contact pin (7) is in the form of a cylinder.

31. The electric lamp as claimed in claim 23, characterized in that the contact pin (7) has an inner diameter of at least 1 mm.

32. The electric lamp as claimed in claim 23, characterized in that the contact pin (7) has sections (7/1, 7/2) with different diameters.

33. The electric lamp as claimed in claim 23, characterized in that substantially two sections (7/1, 7/2) are provided and the diameter of the contact pin (7) at the section (7/2) thereof remote from the lamp (8) is greater than that of the section (7/1) facing the lamp.

34. The electric lamp as claimed in claim 23, characterized in that the contact pin (7) is upset at a point (7/3).

35. The electric lamp as claimed in claim 23, characterized in that that end of the contact pin (7) which faces the lamp (8) is provided with a flange (7/6).

36. The electric lamp as claimed in claim 23, characterized in that the flange (7/6) points outwards.

37. The electric lamp as claimed in claim 23, characterized in that a reflector is provided, which reflector comprises at least one reflector shell (2) which is provided in the vertex region thereof, namely the reflector bottom (5), with at least one opening (6) for receiving a contact pin (7).

38. The electric lamp as claimed in claim 23, characterized in that the contact pin (7) bears with the upset point (7/3) on the outer side of the reflector shell (2) and the flange (7/6) is provided on the inner side of the reflector shell (2).

39. The electric lamp as claimed in claim 23, characterized in that the reflector shell (2) is received between the upset point (7/3) and the flange (7/6).

40. The electric lamp as claimed in claim 23, characterized in that the latching means (7/5) is formed by means of upsetting on the inner side of the contact pin.

41. A reflector lamp comprising a lamp vessel, at least one light-emitting element or electrodes, a power supply system for the light-emitting element or the electrodes, a reflector and contact pins, the power supply system comprising at least two power supply wires, which are connected to the light-emitting element or the electrode, characterized by a connection between the power supply wires (11) and the contact pins (7) as claimed in claim 1.
